(19) United States
(12) Patent Application Publication
(10) Pub. No.: US 2006/0025110 A1
(43) Pub. Date: Feb. 2, 2006

(54) Password protection for mobile phones

(76) Inventor: Jun Liu, Shanghai (CN)

Correspondence Address: PERKINS COIE LLP;PATENT-SEA, P.O. BOX 1247, SEATTLE, WA, 98111-1247, US

(21) Appl. No.: 10/901,783

(22) Filed: Jul. 28, 2004

(51) Int. Cl. H04M 3/16

(52) U.S. Cl. 455/411

(57) ABSTRACT

A method of password protection in a mobile phone. The method utilizes the password mechanism and features of Flash memory for safeguarding the data inside the phone.

### BACKGROUND

Mobile telephones, such as cellular phones, are often equipped with a password or PIN protection feature to prevent unauthorized use of, or access to information stored in, the phones. A mobile phone typically includes man-machine interface (“MMI”) features, which may include, for example, a setting option that allows a user to require the phone to request an access password (or PIN number) every time the phone is turned on. In such a case, whenever the phone is powered on, the phone enters a “lock” mode, and requests the access password from the user. If the user enters the password correctly, the phone exits the lock mode and allows the user to access the various features of the phone. If the user enters an incorrect password, the phone remains in lock mode, indicates that the entered password is incorrect, and requests that the user enter the correct password. As a result, an unauthorized user attempting to use the phone, or obtain data stored in the phone's memory, is unable to access the features of the phone.

Many mobile phones also include a feature that allows a user to set the phone to lock mode at any time while the phone is turned on. Once the lock mode is entered, the phone behaves as described above. Additional security features may also be included to protect information stored in the phone. While these security features are relatively effective at protecting a mobile phone from unauthorized use, several situations may arise where an unauthorized user can still gain access to the features of the phone.

One such situation occurs when an unauthorized user obtains the phone while it is in standby mode, or “unlock” mode. While many mobile phones allow users to “lock” their phones while they are turned on, some users rarely, if ever, think or choose to use this option. Additionally, even if a user has set the phone to request a password at startup, many users rarely, if ever, turn their phones off. Thus, the password protection features of mobile phones often go unused.

Another problem may arise when an unauthorized user finds a way to circumvent the lock mode of a mobile phone. In some mobile phones, for example, an unauthorized user may obtain the phone while it is in lock mode, and then restart the phone, causing the phone to power up in unlock mode. This may be accomplished, in some phones, by simply removing the battery from the phone, and then reinserting the battery. In such a case, if the phone is not set to require an access password at startup, the unauthorized user will gain access to the features of the phone.

When unauthorized users gain access to features of mobile phones, they may acquire confidential data, such as text messages, call records, private phone numbers, etc., that are stored in the phones. Moreover, an unauthorized user may use a mobile phone to place telephone calls, including very expensive international calls, and, in some phones, to access the Internet. The fees for these unauthorized uses, which can be excessive, will then be charged to the accounts of the phone owners. These occurrences can have severe negative emotional and financial effects on a phone owner, as well as on others whose private information is stored in the phone. Thus, a need exists for a mobile phone having improved security, or password protection, features.

### SUMMARY OF THE INVENTION

The invention is directed to enhanced security, or password protection, features for mobile phones, and methods for implementing these features. In one aspect, a method of password-protecting a phone includes enabling a time-based password protection feature in the phone. After a specified duration of phone non-operation elapses, the phone enters a lock mode. A lock mode flag is then set to enabled status in a nonvolatile memory, such as a flash memory, of the phone. When a user attempts to use the phone while it is in lock mode, the phone requests an access password before allowing access to the features of the phone.

In another aspect, a method of password-protecting a phone includes entering a lock mode in the phone when a user manually selects the lock mode. A lock mode flag in a nonvolatile memory of the phone is then set to enabled status. When a user attempts to use the phone while it is in lock mode, the phone requests that the user first enter an access password. The lock mode flag remains set to enabled status in the nonvolatile memory if the phone is restarted, so that the lock mode is entered and the access password is requested when the phone is restarted.

In another aspect, a phone comprises means for enabling a password protection feature in the phone, and means for causing the phone to enter a lock mode after a specified duration of phone non-operation elapses. The phone further includes means for setting a lock mode flag in a nonvolatile memory of the phone to enabled status when the phone is in lock mode, and means for requesting an access password in response to a user attempting to use the phone while the phone is in lock mode.

Other features and advantages of the invention will appear hereinafter. The features of the invention described above can be used separately or together, or in various combinations of one or more of them. The invention resides as well in sub-combinations of the features described.

### BRIEF DESCRIPTION OF THE DRAWING

FIG. 1 is a flow diagram illustrating a method of password-protecting a phone according to one preferred embodiment.

FIG. 2 is a flow diagram illustrating a method of password-protecting a phone during initial startup.

### DETAILED DESCRIPTION OF THE DRAWINGS

The telephone security methods described herein may be implemented in any mobile telephone, such as a cellular phone, or in any other telephone that includes a processor and nonvolatile memory storage, such as flash memory. Flash memory is a type of electrically erasable programmable read-only memory (EEPROM), in which a section of memory cells can typically be erased in a single action, or in a “flash.” Flash memory can be written in blocks, rather than bytes, which makes it relatively easy to update.

A key feature of flash memory is that it retains its data when the device in which it is contained is powered off. Additionally, a flash memory chip, for example, can be electrically erased and reprogrammed without being removed from the circuit board on which it resides. In the mobile phones described herein, nonvolatile memory is preferably embodied in a flash memory card or chip that is insertable into a phone. The nonvolatile memory may alternatively be provided in the phone in or on any other suitable medium.

When an authorized user, such as a phone owner, first selects to enable a security, or password protection, feature in the phone, typically via the phone's man-machine interface (MMI), the user is requested to establish an access password or PIN number. The phone may be pre-programmed with an initial access password, which may be equal to the last four digits of the owner's phone number, the last four digits of the owner's social security number, or any other preset password. While mobile phone passwords typically include 4 digits, the password may include any suitable number of digits or symbols.

In the case where the phone is pre-programmed with an initial access password, the user must correctly enter the password to access the security features of the phone. Once the user correctly enters the initial access password, the user is preferably given the option to change the pre-programmed initial access password to an access password of his/her choosing. In the situation where the phone does not require an initial access password, the user is freely granted access to the security features of the phone to establish an access password.

When the user first establishes an access password, i.e., a user-defined password, he/she may be required to enter the password two or more times to confirm that the password was correctly entered. Once the user-defined access password has been successfully established, it is stored in the memory, preferably the nonvolatile memory, for example, the flash memory, of the phone. This user-defined access password will then be used to lock and/or unlock the phone. The user may be given the option to select whether the access password is required only to unlock the phone, or to both lock and unlock the phone.

In a first embodiment, the mobile phone includes a time-based automatic lock feature, which a user may preferably selectively enable or disable. When enabled, the time-based automatic lock feature causes the phone to automatically enter lock mode after a specified duration of phone non-operation, or after a specified “delay time.” Once the phone enters lock mode, a flag indicating that the phone is in lock mode is set to “enabled,” or “true,” in the nonvolatile, or flash, memory of the phone. The lock mode flag preferably occupies a minimal amount of the phone's nonvolatile memory, for example, one bit of the flash memory of the phone. Any other suitable sized lock mode flag may alternatively be used.

This lock mode flag remains set to “true” until a user correctly enters the access password to unlock the phone. Because the lock mode flag is set in the nonvolatile memory of the phone, it remains set to “true” even after the phone is powered down or restarted by, for example, removing a battery from the phone and then reinserting the battery. Thus, any time the phone is restarted, the phone's processor recognizes that the lock mode flag is set to “true,” and the phone starts up in lock mode.

Accordingly, once the phone has entered lock mode, an unauthorized user who wrongfully obtains the phone cannot access the features of the phone, without first entering the access password. When a user correctly enters the access password, the phone “unlocks,” and the lock mode flag is set to “disabled,” or “false,” in the nonvolatile, or flash, memory of the phone. The lock mode flag is reset to “true” each time that the phone enters lock mode, and remains that way until the access password is correctly entered.

The phone may be programmed with a default delay time, which is preferably modifiable by the user. For example, the phone may be preset to include a five-minute delay time, such that, when the time-based automatic lock feature is enabled, the phone will automatically enter lock mode when no buttons or switches on the phone have been pressed or otherwise manipulated over a five-minute period. The user preferably has the option to modify this delay time so that a shorter or longer period of phone non-operation must elapse before the phone automatically enters lock mode. The delay time is preferably modifiable via the MMI, such as via menus presented on the phone's display, or via another suitable mechanism, such as voice commands. For example, the user may input a specified delay time using the number keys on the phone, and/or may select a delay time from a menu including a preset listing of available delay times.

Some mobile phones include sensitive display screens that can be negatively effected by static images that remain on the display screen for an excessive period of time. For example, a static image may “burn in” to the display screen if the image remains on the display screen for a long period of time. Phones of this type preferably include a screensaver mode that the phone enters after a specified period of time, which may or may not correspond to the delay time required to enter the automatic lock mode. The screensaver images or patterns displayed may preferably be chosen from a preset selection of screensaver images or patterns stored in the phone's memory, or, in some phone models, may be downloaded into the phone's memory from a computer, the Internet, or another suitable source. Alternatively, the phone may include a single preset screensaver image or pattern that is automatically accessed after the specified period of phone non-operation elapses.

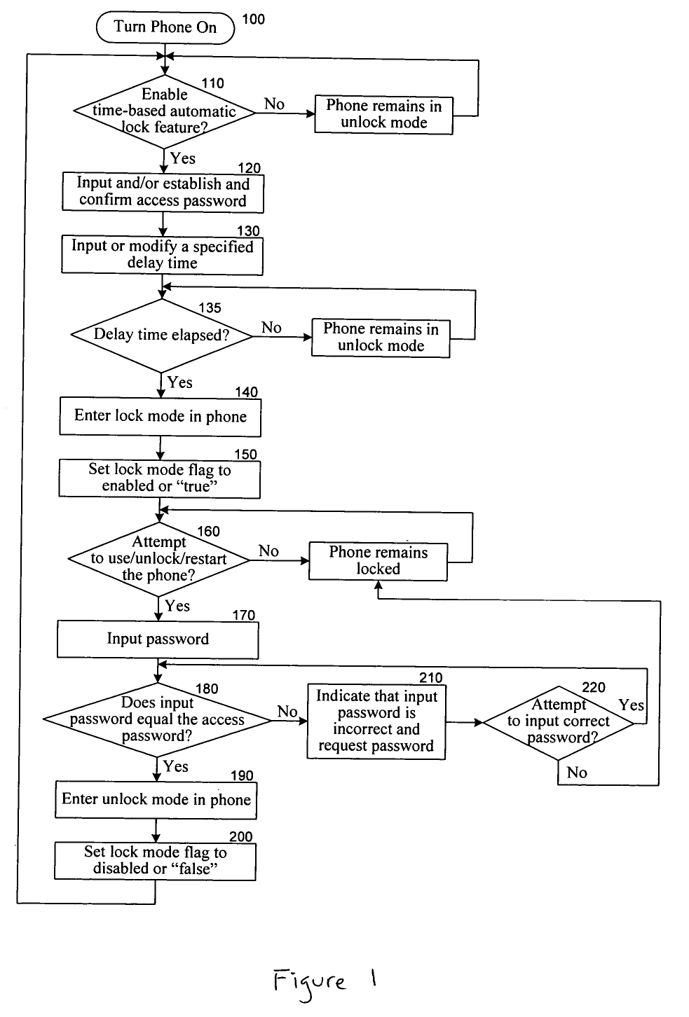

FIG. 1 is a flow diagram illustrating a preferred method of password-protecting a mobile phone using the time-based automatic lock feature described above. All of the steps are preferably performed by a user navigating on-screen menus in the phone, or via another suitable method, such as via a voice recognition program stored in the phone.

At step 100, a user starts, activates, or otherwise powers on, the phone. At step 110, the user chooses whether to enable the time-based automatic lock feature. As explained above, the phone may be preset with an access password that the user must enter, such as the last four digits of the user's phone number, before being allowed to enable the time-based automatic lock feature. In such a case, after the user correctly enters the preset password, the user is preferably given the option to change the access password. If no preset password is required, the user is prompted to establish an access password for locking and/or unlocking the phone. In either case, the user may be required to enter the new password more than once to confirm that the password was entered correctly, as shown at step 120.

The user may then choose to input or modify a specified delay time, i.e., a period of phone non-operation that must elapse before the phone enters lock mode, as shown at step 130. This step may alternatively be performed at any other time during the password-protection setup process. If this step is performed before the access password is input, the user may be required to enter the access password before the delay time can be input or modified, or the delay time may be modifiable without requiring a password.

When the user enables the time-based automatic lock feature, the phone will enter lock mode after the specified duration of phone non-operation, or delay time, has elapsed, as shown at steps 135 and 140. In other words, if no buttons, switches, or other controls on the phone are pressed or otherwise manipulated over the specified delay time period, the phone will enter lock mode when the delay time elapses.

When the phone enters lock mode, a flag indicating that the phone is in lock mode is set to enabled, or “true,” in the nonvolatile, or flash, memory of the phone, as shown at step 150. As explained above, this lock mode flag remains set to “true” even if the phone is powered down or restarted by, for example, removing a battery from the phone and then reinserting the battery. Accordingly, an unauthorized user who wrongfully obtains the phone cannot access the features of the phone by simply restarting the phone.

When a user attempts to use, unlock, or restart the phone, by pressing a button on the phone, for example, as shown at step 160, the phone requests that the user enter the access password before allowing access to the features of the phone. The user then enters a password, at step 170. If the entered password matches the stored access password, as determined by the phone's processor, at step 180, the phone “unlocks” and provides access to the phone's features, as shown at step 190. The lock mode flag is then set to disabled, or “false,” in the nonvolatile, or flash, memory of the phone, at step 200. Accordingly, if the phone is powered off, then back on, or otherwise restarted, while in unlock mode, the phone will not enter lock mode upon startup (unless the user has separately set the phone to automatically enter lock mode at startup).

If the phone (i.e., the phone's processor) determines, at step 180, that the user entered an incorrect password, the phone will indicate that an incorrect password has been entered, and will prompt the user to enter the correct password, at step 210. If the user chooses, at step 220, to attempt to enter the correct password, the phone will determine whether the newly-entered password is correct, at step 180. The process may be repeated until the correct password is entered, or until the user stops attempting to enter the correct password, in which case the phone remains locked.

The phone settings may include an option for limiting the number of times that a user may consecutively enter incorrect passwords before the phone permanently locks. This may be an automatic setting, or may be selectively enabled by a user. If such a feature is enabled, and a password is consecutively entered incorrectly the specified number of times, the phone will lock and/or shut down, and will not be reactivatable without outside authorization, such as from the phone's service provider. Accordingly, if an unauthorized user obtains the phone while it is in lock mode, but does not know the access password, he/she will be prevented from unlocking the phone after the specified number of unsuccessful attempts to enter the correct password have been made. As a result, the data in the phone will be protected, and the unauthorized user will not be able to place calls, or access the Internet, via the phone.

In another embodiment, the user may manually choose to enter lock mode at any time. This feature may be included in addition to, or as an alternative to, the time-based automatic lock feature. In this embodiment, a user manually chooses to enter lock mode, either via a menu option, the press of one or more specified keys (e.g., holding down the # and * keys at the same time, or holding down the # symbol for a specified duration of time), or via another suitable method, such as via voice commands.

When the phone enters lock mode, a flag indicating that the phone is in lock mode is set to enabled, or “true,” in the nonvolatile, or flash, memory of the phone, in the same manner as described above for the time-based automatic lock feature. This lock mode flag remains set to “true” even if the phone is powered down or restarted by, for example, removing a battery from the phone and then reinserting the battery. Accordingly, an unauthorized user who wrongfully obtains the phone cannot access the features of the phone simply by restarting the phone.

As with the time-based automatic lock feature, when a user attempts to use the phone, by pressing a button on the phone, for example, while the phone is in lock mode, the phone requests that the user enter the access password before allowing access to the features of the phone. If the user enters the correct password, the phone “unlocks” and provides access to the phone's features. The lock mode flag is then set to disabled, or “false,” in the nonvolatile, or flash, memory of the phone. Accordingly, if the phone is powered off or otherwise restarted while in unlock mode, when the phone turns on, it will not enter lock mode (unless the user has set the phone to enter lock mode at startup).

If the phone's processor determines that the user entered an incorrect password, the phone will indicate that an incorrect password has been entered. The user will then be prompted to enter the correct password, and the process will be repeated until the correct password is entered, or until the user stops attempting to enter the correct password. As described above, the phone settings may include an option for limiting the number of times a user can consecutively enter an incorrect password before the phone permanently locks or shuts down.

In either or both of the time-based automatic lock and the manual lock embodiments, the phone may enter a screensaver mode, after a specified period of phone non-operation, when the phone is in lock mode or unlock mode, to protect the phone display from “burn in.” The specified duration of time may be the same or different than the delay time specified for the time-based automatic lock feature. If the phone enters the screensaver mode while in lock mode, when a user later attempts to use the phone (e.g., by pressing a button on the phone), the phone will exit screensaver mode but will remain in lock mode. The phone will then request the access password before allowing the user access to the features of the phone, as described above.

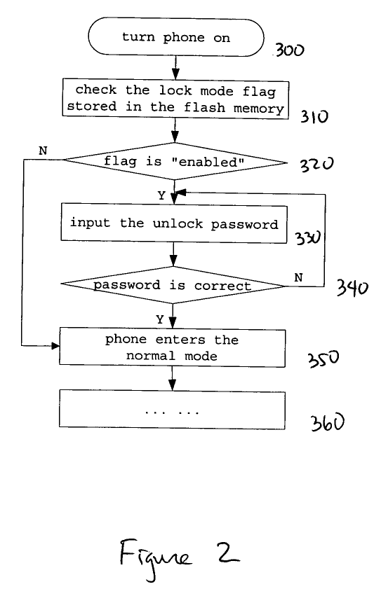

FIG. 2 shows an embodiment when the phone is initially off. The process of FIG. 2, may be added, as one example, betwe steps 100 and 110 of FIG. 1. At step 300, the phone is turned on. At step 310, the lock mode flag is checked, and at step 320, if the lock mode flag is enabled, then the user is prompted at step 330 to input the password. If at step 340, the password is not correct, control returns to step 330 for further prompting of password. If the password is correct, then the phone enters normal operation mode at step 350. Similarly, if the lock mode flag is not enabled at step 320, control goes to step 350 and the phone enters normal operation mode. Finally, step 360 signifies the continued process of FIG. 1.

While embodiments and applications of the present invention have been shown and described, it will be apparent to one skilled in the art that other modifications are possible without departing from the inventive concepts herein. Importantly, many of the steps detailed above may be performed in a different order than that which is described. For example, in the time-based automatic lock mode, a user may set the specified duration of phone non-operation required to trigger the lock mode before setting the access password. The invention, therefore, is not to be restricted except by the following claims and their equivalents.

What is claimed is:

1. A method of password-protecting a phone, comprising the steps of:
enabling a password protection feature in the phone;
entering a lock mode in the phone after a first specified duration of phone non-operation elapses;
setting a lock mode flag, in a nonvolatile memory of the phone, to enabled status; and
requesting an access password in response to a user attempting to use the phone while the phone is in lock mode.

2. The method of claim 1 further comprising the steps of:
comparing a user-entered password to the access password while the phone is in lock mode; and
entering unlock mode if the user-entered password matches the access password.

3. The method of claim 1 wherein the lock mode flag remains set to enabled status in the nonvolatile memory when the phone is restarted so that the lock mode is entered and the access password is requested when the phone is restarted.

4. The method of claim 1 wherein the first specified duration of phone non-operation is modifiable by a user when the phone is not in lock mode.

5. The method of claim 1 wherein the access password is stored in the nonvolatile memory of the phone.

6. The method of claim 1 further comprising the step re-requesting the access password if a user-entered password does not match the access password.

7. The method of claim 6 further comprising the step of the phone remaining in lock mode and not re-requesting the access password if the user enters an incorrect password a consecutive specified number of times.

8. The method of claim 7 wherein the consecutive specified number of times is modifiable by a user when the phone is not in lock mode.

9. The method of claim 1 wherein the phone enters a screensaver mode after a second specified duration of phone non-operation.

10. The method of claim 9 wherein the second specified duration of phone non-operation is modifiable by a user when the phone is not in lock mode.

11. The method of claim 9 wherein the second specified duration of phone non-operation is equal to the first specified duration of phone non-operation, such that the phone enters the lock mode and the screensaver mode substantially simultaneously.

12. The method of claim 1 wherein the nonvolatile memory is embodied on a flash memory chip.

13. A method of password-protecting a phone, comprising the steps of:
entering a lock mode in the phone when a user manually selects the lock mode;
setting a lock mode flag, in a nonvolatile memory of the phone, to enabled status;
requesting an access password in response to a user attempting to use the phone while the phone is in lock mode;
wherein the lock mode flag remains set to enabled status in the nonvolatile memory if the phone is restarted so that the lock mode is entered and the access password is requested when the phone is restarted.

14. The method of claim 13 further comprising the steps of:
comparing a user-entered password to the access password; and
entering unlock mode if the user-entered password matches the access password.

15. The method of claim 13 wherein the access password is stored in the nonvolatile memory of the phone.

16. The method of claim 13 further comprising the step re-requesting the access password if a user-entered password does not match the access password.

17. The method of claim 16 further comprising the step of the phone remaining in lock mode and not re-requesting the access password if the user enters an incorrect password a consecutive specified number of times.

18. The method of claim 17 wherein the consecutive specified number of times is modifiable by a user when the phone is not in lock mode.

19. The method of claim 13 wherein the phone enters a screensaver mode after a specified duration of phone non-operation elapses.

20. The method of claim 13 wherein the phone automatically enters the lock mode after a specified duration of phone non-operation if a user does not manually select the lock mode.

21. The method of claim 13 wherein the nonvolatile memory is embodied on a flash memory chip.

22. A phone, comprising:
means for enabling a password protection feature in the phone;
means for causing the phone to enter a lock mode after a specified duration of phone non-operation elapses;
means for setting a lock mode flag, in a nonvolatile memory of the phone, to enabled status when the phone is in lock mode; and
means for requesting an access password in response to a user attempting to use the phone while the phone is in lock mode.

23. The phone of claim 22 further comprising:
means for comparing a user-entered password to the access password; and
means for causing the phone to enter unlock mode if the user-entered password matches the access password.

24. The phone of claim 23 wherein the lock mode flag remains set to enabled status in the nonvolatile memory when the phone is restarted so that the lock mode is entered and the access password is requested when the phone is restarted.
